(19) United States
(12) Patent Application Publication
(10) Pub. No.: US 2025/0094963 A1
(43) Pub. Date: Mar. 20, 2025

(54) Virtual Card Transactions

(71) Applicant: Oracle International Corporation, Redwood Shores, CA (US)

(72) Inventors: Tapomoy Dey, Santa Clara, CA (US); Harshavardhan Takle, Foster City, CA (US); Rondy C. Ng, Redwood Shores, CA (US); Liam Nolan, Dublin (IE)

(73) Assignee: Oracle International Corporation, Redwood Shores, CA (US)

(21) Appl. No.: 18/820,112

(22) Filed: Aug. 29, 2024

Related U.S. Application Data
(60) Provisional application No. 63/583,295, filed on Sep. 17, 2023.

(51) Int. Cl. G06Q 20/34; G06Q 20/20

(52) U.S. Cl. CPC G06Q 20/351; G06Q 20/204

(57) ABSTRACT

Techniques for managing secure virtual card number (VCN) transactions are disclosed. A POS terminal that processes payments receives an instruction in a secure digital communication over a network to process a payment from a customer to a supplier. Based on receiving a payment request via a network, the POS terminal identifies a VCN associated with the request. The POS terminal validates the VCN and processes the payment request. The POS terminal communicates the VCN to the supplier's bank to initiate a funds transfer between the supplier's bank and the customer's bank that issued the VCN. Upon completion of the transaction, the banks confirm the transaction to the customer and the POS terminal.

### BENEFIT CLAIMS; RELATED APPLICATIONS; INCORPORATION BY REFERENCE

This application claims the benefit of U.S. Provisional Patent Application 63/583,295, filed Sep. 17, 2023, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to virtual credit card processing. In particular, the present disclosure relates to performing virtual credit card transactions by generating complex payment requests from a customer.

### BACKGROUND

Conventionally, financial transactions have been initiated at point-of-sale (POS) terminals via a form of payment being submitted to the POS terminal via a sensor of the POS terminal. In an example, a customer provides a vendor with a form of payment such as a credit card. The vendor manually or electronically via a computing system submits a transaction amount for a financial transaction. Thereafter, the vendor swipes the credit card at the POS terminal for a reader of the POS terminal to detect information from the credit card. If a credit card is a contactless credit card, the vendor may simply “tap” the credit card on the POS terminal. Contactless cards use radio-frequency identification (RFID) and near-field communication (NFC) technologies that enable the credit card to communicate with the POS terminal when the credit card is held near the POS terminal during a transaction. The POS terminal then communicates with a banking institution(s) to execute the financial transaction for the transaction amount. The financial transaction, if successful, transfers the transaction amount from a source account associated with the credit card to a destination account associated with the vendor.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A and 1B illustrate a system in accordance with one or more embodiments;

FIG. 2 illustrates an example set of operations for managing virtual card payments in accordance with one or more embodiments;

FIGS. 3A and 3B illustrate an example embodiment; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. VIRTUAL CARD PAYMENT ARCHITECTURE
3. MANAGING VIRTUAL CARD PAYMENTS
4. PRACTICAL APPLICATIONS, ADVANTAGES, AND IMPROVEMENTS
5. SECURE TRANSACTION EXECUTION AND RECONCILIATION
6. EXAMPLE EMBODIMENT
7. COMPUTER NETWORKS AND CLOUD NETWORKS
8. HARDWARE OVERVIEW
9. MISCELLANEOUS; EXTENSIONS

### 1. GENERAL OVERVIEW

One or more embodiments include a point-of-sale (POS) terminal with functionality to receive instructions over the Internet to initiate a transaction. The POS terminal initiates transactions based on Internet-based instructions. The functionality for receiving instructions over the Internet adds to the POS terminal's conventional functionality that includes receiving direct (point-to-point) instructions via the swiping or tapping of a form of payment directly at the POS terminal.

Prior to accepting Internet-based instructions from a financial institution device, a POS terminal first establishes a trust relationship with the financial institution device. The trust relationship with a financial institution device may be based on factory configuration data stored at the POS terminal or data provided to the POS terminal via an update to the POS terminal. Once a trust relationship is established with a financial institution device, the POS terminal accepts instructions from the financial institution device for initiating payments. Additionally, or alternatively, the POS terminal may receive encrypted instructions from a financial institution. If the public key for the financial institution or a symmetrical encryption/decryption key successfully decrypts the instruction, the POS terminal accepts the instruction.

In some embodiments, the POS terminal initiates a same payment process for Internet-based instructions as for conventional, direct instructions received via swiping or tapping a form of payment at the POS terminal. The POS terminal determines a customer account number based on the Internet-based instruction. Thereafter, the POS terminal generates a new transaction request corresponding to the customer account number. Finally, the POS terminal transmits the new transaction request to a financial institution associated with the customer account number. The financial institution transfers funds from a customer account associated with the customer account number to a supplier account associated with the supplier account number based on the transaction request received from the POS terminal. The customer account number may be a virtual card number (VCN) that is inaccessible to the customer and/or inaccessible to the supplier. The VCN may be a one-time use number created by a financial institution for a single transaction associated with the customer account.

One or more embodiments secure financial information in a VCN transaction by omitting the VCN from communications between a customer's computer system and a supplier's POS terminal. Instead, once a customer has initiated an invoice payment process, the system may connect financial institution systems for the customer and a supplier to provide the VCN to the supplier's financial institution or bank. According to one example, a VCN transaction management platform running on a customer's computing system may generate a VCN transaction identification number (ID) to track an invoice payment instructions and requests associated with a set of invoices. A customer may select the set of invoices in a GUI on a customer device. Based on the customer selection, the VCN transaction management platform generates a VCN transaction ID to pair with the set of invoices. The system may include the VCN transaction ID in messages to and from customer devices and POS terminals. The system may omit VCNs from messages to and from customer computing devices and POS terminals. A customer device may send an invoice payment initiation instruction, including the VCN transaction ID, to a supplier's POS terminal. Additionally, or alternatively, the customer device may send an invoice payment initiation request to the customer's bank that issues VCNs. The customer's bank transfers funds associated with the set of invoices to the supplier's bank without sending the VCN to either the customer's device or to the POS terminal. Upon completion of the funds transfer, the supplier's bank sends the POS terminal a message that includes the VCN transaction ID to confirm the transaction completed. The supplier identifies the invoices associated with the VCN transaction ID to update the supplier's records. Similarly, the customer's bank sends the customer's device a message that includes the VCN transaction ID to confirm completion of the transaction. The customer identifies the set of invoices associated with the VCN transaction ID to update the customer's records.

One or more embodiments present to a customer a user interface for selecting one or more invoices. One supplier may send a first set of invoices to the customer. Another supplier may send a second set of invoices to the supplier. The system presents the first and second sets of invoices along with interface elements to allow the user to select the invoices. The user may select an invoice and an interface element to generate instructions to a POS terminal to initiate a payment process for the invoices. The instruction to the POS terminal may include VCN data. As discussed above, the customer device may be a device managed by the customer or a device managed by a financial institution where the customer has a financial account such as a credit card service provider. Embodiments provide interface elements to allow a user to select multiple invoices for payment. The multiple invoices may be associated with the same supplier or with multiple different suppliers. If the invoices are associated with multiple different suppliers, the customer's computing system may associate a first VCN with invoices associated with one supplier and a second VCN with invoices associated with another supplier. For example, a customer may select in a GUI a first set of invoices from one supplier and a second set of invoices from another supplier. The customer may select a “pay invoices” interface element to transmit a digital instructions to a credit card company with a request to initiate payment of the invoices to the different suppliers. The credit card company may generate or identify two VCNs associated with a real card number (RCN) for the customer. The credit card company sends a first invoice payment instruction with a first VCN to one supplier. The credit card company sends a second invoice payment instruction with a second VCN to another supplier.

One or more embodiments described in this Specification and/or recited in the claims may not be included in this General Overview section.

### 2. VIRTUAL CARD PAYMENT ARCHITECTURE

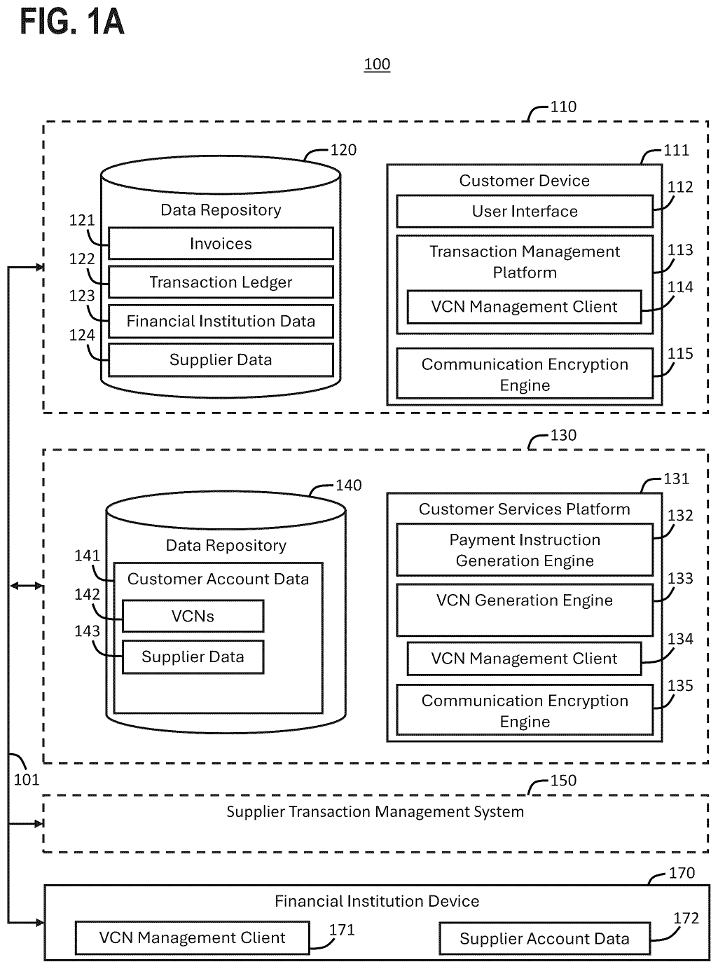

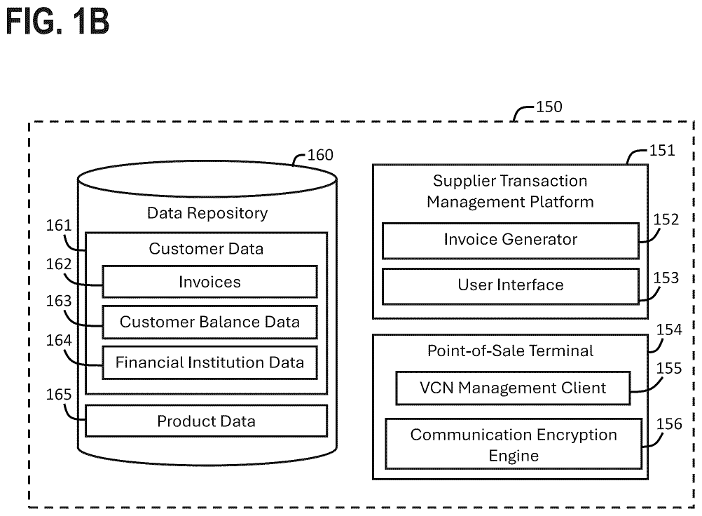

FIGS. 1A and 1B illustrate a system 100 in accordance with one or more embodiments. As illustrated in FIGS. 1A and 1B, system 100 includes customer system 110, a financial service system 130, a supplier transaction management system 150, and a financial institution device 170. In one or more embodiments, the system 100 may include more or fewer components than the components illustrated in FIGS. 1A and 1B. The components illustrated in FIGS. 1A and 1B may be local to or remote from each other. The components illustrated in FIGS. 1A and 1B may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 7, titled “Computer Networks and Cloud Networks.”

A customer system 110 includes a customer device 111 and a data repository 120. The customer device includes a user interface 112, a transaction management platform 113, and a communication encryption engine 115. The financial services system 130 includes a customer services platform 131 and a data repository 140. As illustrated in FIG. 1B, the supplier transaction management system 150 includes a supplier transaction management platform 151 and a data repository 160.

In one or more embodiments, a data repository 120, 140, or 160 is any type of storage unit and/or device (e.g., a file system, database, collection of tables, or any other storage mechanism) for storing data. Furthermore, a data repository 120, 140, or 160 may include multiple different storage units and/or devices. The multiple different storage units and/or devices may or may not be of the same type or located at the same physical site. Furthermore, a data repository 120, 140, or 160 may be implemented or executed on the same computing system as the customer device 111, the customer services platform 131, and the supplier transaction management platform 151. Additionally, or alternatively, a data repository 120, 140, or 160 may be implemented or executed on a computing system separate from the customer device 111, the customer services platform 131, and the supplier transaction management platform 151. The data repository 120, 140, or 160 may be communicatively coupled to the customer device 111, the customer services platform 131, and the supplier transaction management platform 151, respectively, via a direct connection or via a network.

Data illustrated as being stored in the data repositories 120, 140, and 160 may be implemented across any of components within the system 100. However, this information is illustrated within the data repositories 120, 140, and 160 for purposes of clarity and explanation.

A customer accesses the transaction management platform 113 via the user interface 112 to manage transactions between the customer and one or more suppliers. The transaction management platform 113 may provide an interface for a customer to view, modify, and select actions to perform associated with financial transactions. For example, the transaction management platform 113 may present invoices 121 in a GUI. A supplier accessing the supplier transaction management system 150 may transmit invoices to the customer system 110 via the network 101. The transaction management platform 113 stores the invoices 121 in the data repository 120. The transaction management platform 113 may also provide a user interface to allow a user to view invoices, view invoice data, select an invoice for payment, and select batches of invoices for payment, where a batch includes two or more invoices. According to one example, the transaction management platform 113 presents a user interface to allow a user to concurrently select invoices to different suppliers for payment.

In one or more embodiments, the transaction management platform 113 presents transaction ledger 122 data in a GUI. For example, the GUI may display invoices outstanding, invoices paid, amounts outstanding, amounts paid, and timelines associated with outstanding and paid invoices, such as when invoices were received and when invoices are due.

The transaction management platform 113 may further store financial institution data 123 in the data repository 120. Financial institution data may include, for example, a name, other identifying information, an account number, and a routing number. Financial institutions include banks and credit card companies. The transaction management platform 113 further stores supplier data 124 in the data repository 120. Supplier data 124 includes names of suppliers, product information associated with the suppliers, contact information, and account information associated with suppliers, such as information identifying a financial institution associated with a supplier. In one or more embodiments, contact information associated with a supplier includes information identifying any security requirements, such as data encryption requirements, for transmitting data to a supplier and for receiving data from the supplier.

In one or more embodiments, the customer device 111 runs a virtual card number (VCN) management client 114. The VCN client 114 may communicate via encrypted communications with VCN management clients 134, 155, and 171 of the financial services system 130, the supplier transaction management system 150, and the financial institution device 170 to generate, transmit, and process communications associated with financial data. For example, the VCN management clients 114, 134, 155, 171 may facilitate transmitting instructions to pay a POS terminal, initiating a payment request by the POS terminal, processing the payment request, verifying the payment request, executing the payment request, and transferring money between financial accounts while keeping VCNs hidden from one or both of a customer system (e.g., the system 110) and a supplier system (e.g., the system 150).

A communication encryption engine 115 encrypts messages transmitted from the customer device 111 to one or more of the customer services platform 131, the supplier transaction management platform 151, and the financial institution device 170.

In one or more embodiments, the customer device 111 determines if a digital message contains financial information associated with a customer or a supplier. The customer device 111 encrypts messages to external devices if the messages include financial information. For example, the communication encryption engine 115 may encrypt payment requests sent from the customer device 111 to the customer services platform 131 and the supplier transaction management platform 151.

Examples of encryption methods include a Transport Layer Security (TLS) or Secure Sockets Layer (SSL) protocol. The communication encryption engine 115 may encrypt online communications between a web browser running on the customer device 111 and a website managed by the supplier transaction management system 150 using TLS. The communication encryption engine 115 may encrypt the online communication using a combination of symmetric encryption and asymmetric encryption to secure the data. Same encryption refers to when a same encryption key is used for both encryption and decryption. Asymmetric encryption refers to encryption using a combination of public and private keys to secure data.

Referring to FIG. 1B, the supplier transaction management platform 151 includes an invoice generator 152. When a customer purchases goods or services, the supplier transaction management platform 151 generates one or more invoices 162 for the transactions using the invoice generator 152. The supplier transaction management platform 151 stores additional customer data 161 in a data repository 160. Examples of customer data 161 include invoices 162 associated with the customer, customer balance data 163 associated with balances due to the supplier, and financial institution data 164. For example, a customer and a supplier may exchange financial institution data 164 to facilitate transactions over the network 101 and to confirm payment requests associated with a customer are valid. In one or more embodiments, the supplier transaction management system 150 further stores product data 165, such as inventory data and data specifying products associated with different customers.

A POS terminal 154 receives and executes invoice payment transaction instructions. The POS terminal 154 is a hardware device that processes payments and logs transactions. The POS terminal 154 allows customers to make payments using credit cards, debit cards, and electronic wallets. The POS terminal 154 includes sensors to detect payment devices, including magnetic strip readers and radio frequency identification (RFID) readers to read magnetic strips and RFID chips on payment cards and in electronic devices such as cellular smartphones. The POS terminal 154 may be found in a physical stores. Additionally, or alternatively, the POS terminal 154 may be a mobile terminal connected to, or incorporated in, mobile devices, such as laptops, tablet computers, and smartphones. The POS terminal may receive invoice payment instructions from customers or from financial institutions. For example, the POS terminal 154 may receive an instruction from the customer device 111 to initiate a payment process for paying the customer's invoices. Additionally, or alternatively, the POS terminal 154 may receive a transaction instruction from the financial services system 130 to initiate the payment process to pay the customer's invoices. Based on receiving invoice payment instructions, the POS terminal 154 communicates with one or both of the financial services system 130 and the financial institution device 170 to initiate a payment request. The POS terminal 154 may validate the instruction and execute the transaction. The POS terminal includes a communication encryption engine 156 to encrypt messages transmitted from the POS terminal 154 to external devices.

A financial services system 130 includes a customer services platform 131. The customer services platform manages data and transactions associated with customers. The customer services platform 131 includes a payment instruction generation engine 132. The payment instruction generation engine 132 generates invoice payment instructions to supplier systems, and in particular to POS terminals in supplier systems. For example, a customer may initiate an invoice payment process by transmitting a request from the customer device 111 to the financial services system 130 to generate invoice payment instructions. The payment instruction generation engine 132 identifies one or more virtual card numbers (VCNs) 142 associated with the request. The payment instruction generation engine 132 may also validate a supplier identified in the request based on supplier data 143 stored in customer account data 141 for the customer initiating the invoice payment process. A VCN generation engine 133 generates one or more virtual card numbers for invoice payment instructions. In one example, a customer services platform 131 maintains a set of one or more previously-generated VCNs 142 associated with a customer. According to another example, the payment instruction generation engine 132 generates one or more VCNs 142 based on receiving an invoice payment initiation request from a customer. For example, the payment instruction generation engine 132 may verify that the customer associated with an invoice payment initiation request is entitled to a one-time VCN for use with a transaction. The VCN generation engine 133 generates the VCN, stores the VCN 142 in the customer account data 141, and transmits the VCN to the supplier transaction management system 150 to execute a payment instruction. The customer services platform 131 includes a communication encryption engine 135 to encrypt messages transmitted from the customer services platform 131 to external devices.

As used herein, an invoice payment instruction, or “payment instruction”, is a communication received by a POS terminal 154 of a supplier transaction management system 150 from a customer system 110 or a financial services system 130. A payment request is a communication transmitted by a POS terminal 154 in response to receiving the invoice payment instruction. The POS terminal 154 transmits the payment request to one, or both, of the financial institution device 170 for a financial institution that manages supplier accounts and the financial services system 130 that manages customer accounts. Prior to generating the invoice payment instructions to the POS terminal 154, a customer's financial institution may receive an invoice payment initiation request from the customer.

In addition to encryption processes described above, the communication encryption engine 135 may utilize a tokenization process to protect sensitive information such as customer account numbers. The communication encryption engine 135 replaces sensitive payment details, such as credit card numbers, with a unique token that can be used for the transaction but has no value outside of the transaction context. In addition, the communication encryption engine 135 may utilize additional security processes such as two-factor authentication. In two-factor authentication, the customer services platform 131 may require customers to provide two forms of verification (such as a password and a code sent to their phone) before completing a transaction.

In one or more embodiments, the supplier transaction management system 150 communicates with a financial institution device 170 to execute an invoice payment transaction. For example, a supplier may have a financial account with the financial institution that maintains the financial institution device 170. The financial institution device 170 stores supplier account data 172, such as an account balance and transaction information. Based on a request received from the supplier transaction management system 150, the financial institution device 170 may communicate with the financial services system 130 to transfer money from an account associated with the customer and the financial institution system to an account associated with the supplier and the financial institution device 170.

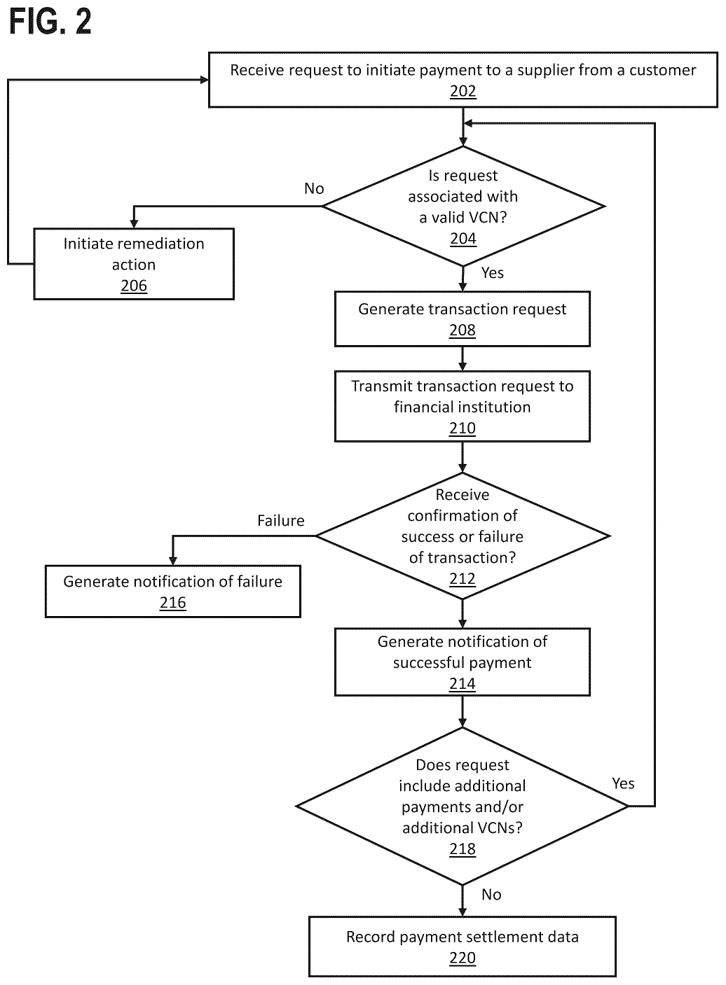

In one or more embodiments, customer device 111 refers to hardware and/or software configured to perform operations described herein for initiating payment requests to supplier systems based on invoice records. Customer service platform 131 refers to hardware and/or software configured to perform operations described herein for generating and storing virtual card numbers, receiving customer requests, and generating digital communications to initiate payment requests associated with customers and corresponding virtual card numbers. The supplier transaction management platform 151 refers to hardware and/or software configured to perform operations described herein for receiving payment requests and generating digital communications with external systems to validate and process the payment requests. Examples of operations for implementing virtual card transactions are described below with reference to FIG. 2.

In an embodiment, a supplier transaction management platform 151, a POS terminal 154, a customer device 111, and a customer services platform 131 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, interfaces 112 and 153 refer to hardware and/or software configured to facilitate communications between a user and hardware devices and applications running on the hardware devices. Interfaces 112 and 153 render user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interfaces 112 and 153 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interfaces 112 and 153 are specified in one or more other languages, such as Java, C, or C++.

### 3. MANAGING DIGITAL COMMUNICATIONS FOR VIRTUAL CARD NUMBERS

FIG. 2 illustrates an example set of operations for managing digital communications associated with payment requests and virtual card numbers in accordance with one or more embodiments. One or more operations illustrated in FIG. 2 may be modified, rearranged, or omitted. Accordingly, the sequence of operations illustrated in FIG. 2 should not be construed as limiting the scope of one or more embodiments.

In an embodiment, a POS terminal receives an instruction initiate payment to a supplier from a customer (Operation 202). The instruction may be received as an encrypted digital message. The message may be sent by a device associated with a customer or a device associated with a financial institution.

For example, a supplier may transmit a set of invoices to a customer. The invoices correspond to transfers of goods and/or services from the supplier to the customer. The invoices specify the goods and/or services, and payment amounts owed by the customer to the supplier. The customer may interact with a GUI presented on a display device to select a set of one or more invoices for payment. The customer may transmit identifying information for the set of invoices to a financial institution, such as a credit card company. The customer has an account with the financial institution. The customer transmits the invoice identifying information together with supplier identifying information and a request that the financial institution pay the supplier the amounts specified invoices.

Based on receiving the request from the customer to initiate an invoice payment process, the financial institution verifies the customer account data. In one embodiment, the financial institution verifies that the customer and the supplier are valid parties to a financial transaction initiated by the financial institution. For example, the customer, the supplier, and the financial institution may be registered on a VCN management platform. The VCN management platform allows participants to transmit encrypted financial data associated with payment requests and VCNs between devices maintained by the participants. In one embodiment, devices managed by the customer, the supplier, and the financial institution, respectively, run a client application for generating, encrypting, and transmitting digital communications associated with payment requests and VCNs.

In one embodiment, the financial institution verifies that the customer account is associated with one or more VCNs. A customer account may be associated with a customer account number. The customer account number is different from a VCN. In addition, a customer may have a physical card displaying a card number. The VCN may be different from the physical card number. In one embodiment, the VCN is a temporary, digital number issued by the financial institution. The VCN may be used to perform online transactions or transactions initiated and executed over a network such as the Internet. The VCNs may be viewable by a customer. For example, a customer may log in to an interface maintained by the financial institution to view a set of one or more VCNs associated with the customer account. According to an alternative embodiment, the VCNs are not viewable by the customer. In this embodiment, the financial institution may initiate and execute operations to pay invoices, including transferring money from a customer account to a supplier account, without the customer having an ability to view a VCN used in the transaction.

Based on receiving the request from the customer and verifying the set of one or more VCNs associated with the customer account, the financial institution generates an encrypted digital message including at least (a) invoice identifiers for one or more invoices and (b) identifying information associated with the customer account. In one embodiment, the identifying information includes a VCN. In an alternative embodiment, the identifying information omits any VCN. For example, if the identifying information includes a VCN, the supplier receiving the digital message may transmit the VCN to the supplier's financial institution. However, in an embodiment in which the identifying information does not include the VCN, the supplier may instead initiate a payment process, where the customer's financial institution is put into direct communication with the supplier's financial institution. In one or more embodiments, the encrypted digital message generated by the financial institution is a set of data in a format corresponding to the POS terminal. The set of data may be in a format that a computer may initiate a payment process without presenting invoice data and payment data to a human. Additionally, or alternatively, the POS terminal may be in communication with a display device to display the payment request data to a user. A user may view the payment data and/or confirm that the payment request process may proceed.

According to an alternative embodiment, a client device generates and transmits a digital communication to the supplier without sending any request to a financial institution. A client device may run a VCN management application client. The VCN management application client may store a set of one or more VCNs generated by a financial institution and associated with a customer account at the financial institution. The digital communication from the client device to the supplier may include information identifying a set of invoices and information associated with the customer's account at the financial institution. In one embodiment, the information associated with the customer's account at the financial institution includes a VCN. In an alternative embodiment, the information associated with the customer's account at the financial institution omits any VCN. For example, if the customer's digital communication includes a VCN, the supplier receiving the digital message may transmit the VCN to the supplier's financial institution. However, in an embodiment in which the customer's digital communication does not include the VCN, the supplier may instead use the information identifying the customer's account at the financial institution to initiate a payment process, where the customer's financial institution is put into direct communication with the supplier's financial institution.

In one or more embodiments, a VCN management application client presents a GUI to provide a user with an option to make a VCN visible to a customer or to hide the VCN from the customer. Similarly, the GUI may provide a user with the option to make the VCN visible to a supplier or to hide the VCN from the supplier. A customer may select a set of invoices to be paid and an icon representing hiding the VCN from the supplier. As a result, a digital communication generated by the VCN management application client may include financial institution information without including a VCN number. The supplier may initiate payment of the invoices by transmitting the financial institution information for a customer's financial institution to the supplier's financial institutions. The financial institutions may complete a funds transfer using a VCN without the supplier seeing the VCN.

In one or more embodiments, an instruction to initiate a payment process includes identifying information of multiple invoices. A customer device may run an invoice management application that provides the customer with the ability to view and concurrently select multiple invoices for payment. A payment request may include identifying information for one VCN to be used to pay the amounts in multiple invoices. In an embodiment in which the customer transmits a request to a financial institution, such as a credit card service provider, to pay a set of invoices, the invoices may include one or more invoices associated with different suppliers. The financial institution may generate multiple different digital communications to the multiple different suppliers. The different digital communications may include different VCNs for the different suppliers.

According to one or more embodiments, a customer system, a supplier system, and a financial services system encrypt digital communications between the systems that include proprietary and/or financial data. Examples of encryption methods include implementing Transport Layer Security (TSL) protocols, using public and private encryption keys, using secure payment gateways, tokenizing sensitive information, such as VCNs, in digital communications, and implementing two-factor authentication. The POS terminal decrypts the encrypted digital communications to identify at least invoice information specifying one or more invoices to be paid and financial institution information, such as account data or a VCN.

A system determines if the instruction to initiate an invoice payment process is associated with a valid VCN (Operation 204). According to one example embodiment, the POS terminal receives an encrypted digital communication from a customer device. The encrypted digital communication includes a number identified as a VCN. The POS terminal generates a transmission to a financial institution associated with the VCN to verify the VCN is valid. According to another example embodiment, the encrypted digital communication includes identifying information for a customer's account with a financial institution, while omitting both a real card number (RCN) and the VCN. The POS terminal generates a transmission to the financial institution to request a VCN to complete the payment.

According to yet another example embodiment, the POS terminal receives an encrypted digital communication from a financial institution. The encrypted digital communication includes a number identified as a VCN. Determining that the VCN is valid may include determining that one, or both, of the customer identified in the digital communication and the financial institution identified in the digital communication are trusted entities. For example, a VCN management platform may include identification information for trusted suppliers, customers, and financial institutions. These entities may be identified as “trusted” based on providing information, such as government-issued identifiers, identifiers from other governing bodies, and other types of identification.

If the system determines the VCN is not valid, the system initiates remediation action (Operation 206). For example, the POS terminal may generate a digital communication requesting the sending entity re-send the request for payment. Additionally, or alternatively, the POS terminal may generate a notification to a customer and/or a financial institution regarding the failed request. Additionally, or alternatively, the POS terminal may flag the request for human review.

If the system determines the VCN is valid, the system processes the payment. The POS terminal generates a transaction request (Operation 208). In one embodiment, the POS terminal generates a transaction request including (a) an account number, such as a VCN number, associated with a customer, and (b) an amount associated with the payment initiation instruction.

The POS terminal transmits the transaction request to a financial institution (Operation 210). In one embodiment, the POS terminal receives an encrypted payment initiation instruction from a customer's financial institution and transmits a payment initiation request to a supplier's financial institution. The supplier's financial institution maybe, for example, a bank that stores funds for the supplier. The supplier's financial institution transmits an encrypted digital message to a customer's financial institution. The customer's financial institution may be the issuer of the VCN. The financial institutions may initiate a transfer of funds between the institutions.

In one or more embodiments, the POS terminal sends a payment authorization request to one or both of the customer's financial institution and the supplier's financial institution. One or both of the supplier's financial institution and the customer's financial institution may send the POS terminal authorization information confirming the payment is authorized.

According to another embodiment, the POS terminal that received the payment process initiation instruction transmits an encrypted digital message, including account data, that may exclude any VCN, to the supplier's financial institution. As discussed above, the account data that does not include the VCN may include an account identifier associated with the customer's account at the customer's financial institution. Additionally, the account data may include a VCN transaction ID that may be processed by the financial institution to identify the customer associated with the VCN transaction ID. In these embodiments, the VCN used to execute a transfer between the customer's financial institution and the supplier's financial institution remains hidden from the supplier. Based on receiving the account data that does not include the VCN, the supplier's financial institution transmits an encrypted digital message to a customer's financial institution. The customer's financial institution provides the supplier's financial institution with a VCN to complete the transaction. The financial institutions may initiate a transfer of funds between the institutions.

The POS terminal determines whether it has received a confirmation of the success or failure of the transaction (Operation 212). The POS terminal may receive the confirmation from the supplier's financial institution.

If the POS terminal determines the transaction failed, the POS terminal generates a failure notification (Operation 216). The POS terminal may transmit the notification to a customer. The notification may include an indication of a reason for the failure, such as “insufficient funds,” “invalid VCN,” “expired VCN,” “supplier not accepting VCN payments,” etc.

If the POS terminal determines the transaction succeeded, the POS terminal generates a notification of the successful transaction (Operation 214). The POS terminal may transmit the notification to the customer. In addition, the POS terminal may transmit the notification to a supplier's invoice management system or application.

The system determines if the payment process initiation instruction includes one or more additional payments associated with one or more additional transactions (Operation 218). For example, some payment instructions may specify a single invoice and a single VCN for paying charges in the invoice. However, other payment instructions may specify multiple invoices and a single VCN for payment of the charges in the multiple invoices. According to yet another embodiment, the payment instruction may include a first set of invoices, a first VCN for payment of the charges in the first set of invoices, a second set of invoices, and a second VCN for payment of the charges in the second set of invoices.

If the system determines the payment process initiation instruction includes one or more additional payments associated with one or more additional transactions, the system determines if the VCN(s) associated with the additional transaction(s) is/are valid (Operation 204). For example, a customer's financial institution may implement a set of rules for VCN usage. The rules may specify that one VCN may be used for a specified number of transactions, or that one VCN may be used for any number of transactions in a single payment request to a single POS terminal. Additionally, or alternatively, the rules may specify that a single VCN may be used to pay charges on any number of invoices associated with a single payment instruction sent from a customer, or a customer's financial institution, to a supplier. For example, a customer may select ten invoices in a GUI for payment. Five invoices may originate from a first supplier. Five invoices may originate from a second supplier. A customer device may transmit a payment initiation request to the customer's financial institution. The customer's financial institution may generate (a) a first encrypted digital payment instruction to a first POS terminal associated with the first supplier to initiate payment of the first set of five invoices and (b) a second encrypted digital payment instruction to a second POS terminal associated with the second supplier to initiate payment of the second set of five invoices. Based on the instructions resulting from the same payment process initiation request from the customer to the customer's financial institution, the customer's financial institution may include the same VCN in the two different payment instructions to the two different POS terminals.

If the system determines the payment instruction does not include additional transactions in Operation 218, the system records the payment settlement data (Operation 220). In one embodiment, the supplier's financial institution transmits a confirmation to the POS terminal to confirm initiation of a payment process from the customer's financial institution to the supplier's financial institution. A supplier's accounting system may record amounts associated with invoices included in the payment request as being paid. In an embodiment in which the VCNs associated with payments are hidden from a supplier, the supplier's financial institution may include a transaction identifier that the supplier maps to a set of payment amounts for a set of invoices. Accordingly, the supplier records payment of the amounts specified in the invoices without having access to the VCN used to pay the amounts. The supplier's accounting system may further present confirmation data and transmit the confirmation data to additional devices. In one embodiment, the supplier's accounting system transmits a message to a customer device to confirm payment or initiate a payment process.

Additionally, or alternatively, the customer's financial institution may generate a message to the supplier that the payment was initiated and/or completed. For example, the customer may send a request to the customer's financial institution to pay a set of invoices from a supplier. The financial institution may transmit an encrypted digital communication to the supplier identifying the invoices and requesting initiation of a payment process. The customer's financial institution may interact with the supplier's financial institution to transfer funds from a customer account with the customer's financial institution to a supplier account with the supplier's financial institution. The financial institutions may transfer the funds using a VCN associated with the customer's account. Based on completing the transfer, the customer's financial institution may send confirmation to the customer that the amounts associated with the invoices had been paid.

### 4. PRACTICAL APPLICATIONS, ADVANTAGES, AND IMPROVEMENTS

One or more embodiments further point-of-sale (POS) terminal technology by implementing a new method of receiving an instruction to initiate a payment. Embodiments include POS terminals that receive instructions over the Internet for initiating payments. In order to trust instructions received over the Internet from financial institution devices, POS terminals are configured to (a) establish trust relationships with financial institution devices and/or (b) verify that instructions are in fact from trusted financial institutions based on successful decryption. In some embodiments, POS terminals extend the benefits of initiating transaction requests via the POS terminals, that were previously limited to direct requests received at the POS terminals, to Internet-based instructions received from financial institutions.

One or more embodiments provide a secure computer environment for transmitting digital communications among computer systems to execute financial transactions. Embodiments communicate among (a) a customer's computer system, (b) at least one financial institution computer system where a customer has an account, (c) a POS computer terminal run by a suppler as well as any supporting computer system maintained by the supplier, and (d) at least one financial institution computer system where the supplier has an account. Embodiments may provide the secure computer environment by hiding account numbers from parties in the transaction. For example, an embodiment hides a virtual card number associated with a customer's account from one or both of (a) the customer and (b) a supplier. In one embodiment, the system hides the VCN during the invoice payment process by omitting the VCN from encrypted transactions to and from a customer's computing system and a supplier's computing system including a POS terminal. However, the system may allow the customer to view the VCNs associated with executing invoice payment processes by other means, such as by interacting with a financial institution's website or an application running on the customer's system that has access to the customer's VCNs.

One or more embodiments further provide a cross-platform system to allow customers to pay invoices with VCNs. Customers, suppliers, and financial institutions may register with the cross-platform system. Registration includes verifying the following: customer and supplier information, communications channel information, account information of a customer's account with the customer's financial institution, and the supplier's account with the supplier's financial institution. Registration may further include the granting of permissions to initiate payments using VCNs. Based on the registration, different systems may access information obtained during registration to securely communicate with each other to execute payments. For example, a supplier may transmit a set of invoices to a customer with a first identification number (ID). The customer's system may identify the ID as being associated with the supplier and as indicating that the supplier accepts VCN payments. The customer transmits the invoice data and the first ID to the customer's financial institution to begin the process of paying the amounts specified in the invoices. One or both of the customer and the customer's financial institution may transmit a second ID to the supplier. The second ID may inform the supplier and/or the supplier's financial institution that the customer and/or the customer's financial institution are authorized to pay with VCNs. The supplier may also use the second ID to determine communication protocols for communicating with the customer and/or the customer's financial institution. For example, a particular ID may be associated with a particular encryption key. The supplier may use different encryption keys to communicate with different entities corresponding to different IDs.

One or more embodiments provide a VCN transaction ID to track a transaction among entities and maintain financial information confidential. A customer may select a set of invoices for payment. The customer computer system may transmit the invoice information together with the VCN transaction ID to the customer's financial institution. In one embodiment, the customer's financial institution may transmit the invoice information and VCN transaction ID to a supplier's computer system. The customer's financial institution may refrain from transmitting a VCN to the supplier's computer system. The supplier may confirm invoices and amounts and transmit the VCN transaction ID to the supplier's financial institution to complete payment. In an alternative embodiment, the customer's financial institution directly contacts the supplier's financial institution without first contacting the supplier's computer system. Since the supplier's financial system only knows an amount to be transferred and not particular invoices, the supplier's financial system may transmit the VCN transaction ID to the supplier and to the customer's financial institution. The supplier identifies the invoices associated with the VCN transaction ID. Similarly, the customer's financial institution sends to the customer a confirmation of payment. By providing a VCN transaction ID associated with (a) a particular VCN and (b) a particular set of invoices, multiple different systems may execute and record the payment of invoices without transmitting both the VCN and the invoice numbers to the systems.

### 5. SECURE TRANSACTION EXECUTION AND RECONCILIATION

One or more embodiments provide a secure platform for executing transactions using virtual card numbers (VCNs). Customer computer systems, supplier computer systems, and financial institution computer systems may register with the secure platform to identify a set of trusted parties to financial transactions. Customers may apply for an account with an issuing bank that corresponds to an account number, at least one real card number (RCN), and one or more VCNs. The issuing bank may be, or be affiliated with, a credit card company, for example.

A VCN management application client running on a customer's device may store account information associated with the issuing bank. For example, the VCN management application client may store the customer's account number with the issuing bank and one or more VCNs associated with the customer's account.

A supplier may register with the VCN management application to receive payments via VCN from one or more customers. A supplier computer system may run the VCN management application client. The supplier may provide information such as account numbers, routing information, and information associated with any financial institutions where the supplier has accounts that receive VCN payments. In one embodiment, the VCN management application stores straight through processing (STP) IDs for customers and suppliers.

In one embodiment, the VCN management application client includes, or is part of, a transaction management application such as a bookkeeping application. In one embodiment, the VCN management application manages encryption of communications among registered entities. The VCN management application may define encryption schemes for encrypting communications between registered entities. For example, the VCN management application may store public and private keys for encrypting communications.

If a customer receives a set of invoices from a supplier, the customer may select one or more invoices for payment in a payment management GUI. The VCN management application client may verify that the supplier associated with the selected invoices is registered to receive VCN payments. The VCN management application client running on the customer system transmits an encrypted communication to the VCN management application client running on the supplier system. Alternatively, the VCN management application client may transmit a request to the issuing bank to initiate payment.

The VCN management application client running on the supplier system may extract the customer's VCN management ID from the encrypted communication. The supplier system may then initiate communication between the supplier's financial institution and the customer's financial institution to exchange funds using a VCN provided by the customer's financial institution. The financial institutions may notify the customer and the supplier upon (a) initiation of the payment and (b) completion of the payment. The notifications may include one or more identifiers that identify the transactions as being associated with a set of invoices. Accordingly, the customer and the supplier may update that status of invoices and payments in their respective bookkeeping applications to indicate the invoices have been paid.

### 6. EXAMPLE EMBODIMENT

A detailed example is described below for purposes of clarity. Components and/or operations described below should be understood as one specific example that may not be applicable to certain embodiments. Accordingly, components and/or operations described below should not be construed as limiting the scope of any of the claims.

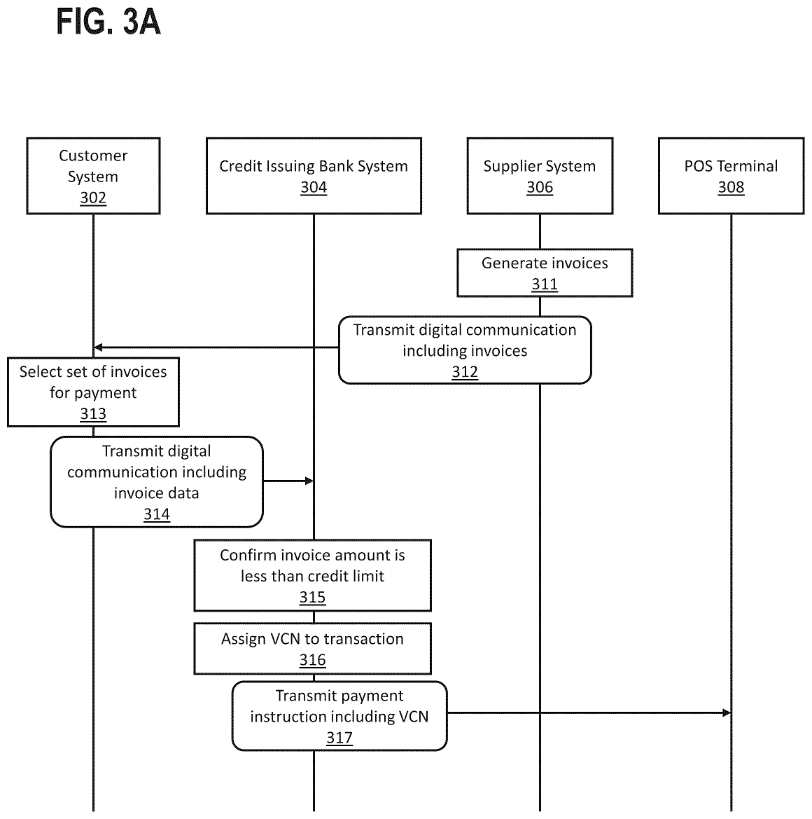

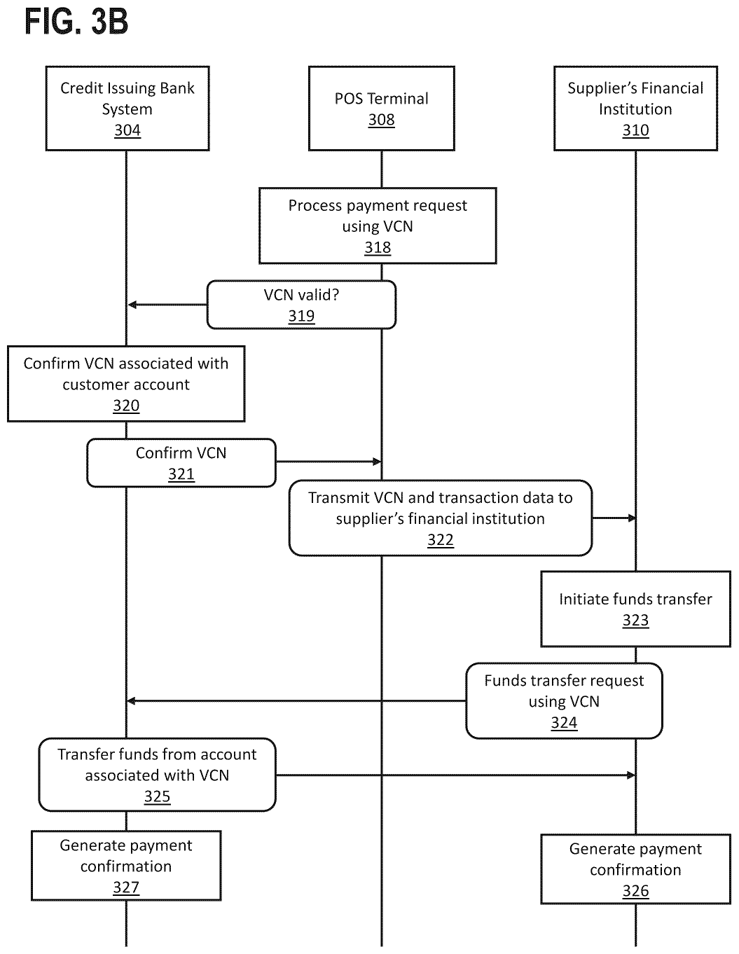

FIGS. 3A and 3B illustrate a secure VCN transaction management system and process according to an example embodiment. A customer system 302 includes a customer's computing device. The supplier system 306 also includes at least one computing device, including a POS terminal. The customer system 302, credit issuing bank system 304, and supplier system include hardware and software to store VCN transaction data, generate secure digital communications, transmit the secure digital communications to external devices and systems, and receive and process secure digital communications.

Referring to FIG. 3A, the supplier system generates a set of invoices (Operation 311). The invoices correspond to purchases of goods and/or services by the customer from the supplier. The invoices may be digital files. The invoices specify the goods and/or services and amounts owed by the customer to the supplier.

The supplier system 306 transmits a digital communication including the invoices to the customer system (Operation 312). The supplier system 306 may determine that the communication includes sensitive information. The supplier system 306 may encrypt the communication to the customer system 302. In one embodiment, the supplier system 306 and the customer system 302 run a VCN management application client. The VCN management application client stores encryption data, such as encryption keys, used by the supplier system 306 and the customer system 302 to transmit messages.

A customer accesses an invoice management GUI in the customer system 302 to select a set of invoices for payment (Operation 313). The invoices may include one invoice or multiple invoices. The invoices may be from a single supplier or from multiple different suppliers. The customer system 302 may present to a user a list of outstanding invoices awaiting payment. The customer system 302 may present or identify invoices associated with suppliers that accept VCN payments. For example, the credit issuing bank system 304 may store and maintain a list of suppliers that accept VCN payments.

The customer system 302 transmits invoice data for the selected in voices to the credit issuing bank system 304 in a digital communication (Operation 314). In an embodiment in which the customer system 302 runs a VCN transaction application client, the customer system 302 may generate and include with the digital communication to the issuing bank system 304 a VCN transaction ID. The customer system 302 may map the VCN transaction ID to (a) the customer, and (b) the selected set of invoices. When the customer system 302 receives secure digital communications that include the VCN transaction ID, the customer system 302 may identify the set of invoices associated with the VCN transaction ID.

In one embodiment, transmitting the digital communication to the credit issuing bank system 304 includes calling a “create purchase request” application programming interface (API) function of the VCN transaction application client. In addition, calling the “create purchase request” API function may cause the VCN transaction application client to generate and transmit a digital message to the supplier system 306. The digital message to the supplier system 306 may include a notification that a payment process has been initiated. The digital message to the supplier system 306 may further include the VCN transaction ID and invoice data associated with the VCN transaction ID. The digital message to the supplier system 306 may inform the supplier system that digital communications that include the VCN transaction ID are associated with a specified set of invoices.

The credit issuing bank system 304 confirms that the credit available to the customer exceeds the amount due in the set of selected invoices (Operation 315). The credit issuing bank system 304 identifies a credit account associated with the customer. The credit account may include one or more account numbers. One account number may be an RCN. The RCN may be a sixteen-digit card number that the customer may use to charge transactions to the credit account. The credit issuing bank system 304 further identifies a set of one or more VCNs associated with the customer's account.

The credit issuing bank system 304 assigns a VCN to the transaction to pay the specified set of invoices (Operation 316). In an embodiment in which the customer has selected invoices from multiple different suppliers, the credit issuing bank system 304 may assign a separate VCN to the payment of invoices of each separate supplier.

The credit issuing bank system 304 transmits an invoice payment process initiation instruction to the point-of-sale (POS) terminal 308 that includes the VCN (Operation 317). The VCN may be a one-time use VCN whose validity is limited to the transactions associated with the payment of the selected invoices. Subsequent transactions associated with other invoices may require use of a different VCN.

Referring to FIG. 3B, the POS terminal 308 receives the payment request from the credit issuing bank system 304 and processes the payment request including the VCN (Operation 318). The POS terminal 308 may process the payment request including the VCN in the same manner as a physical swipe of a physical card including an RCN. In an embodiment in which the supplier system 306 registers with a VCN transaction platform, the POS terminal 308 may communicate the VCN and/or the invoice payment instruction to the supplier system 306. The supplier system 306 may verify that the credit issuing bank is authorized to initiate VCN payments. The supplier system 306 may further verify that the customer is authorized to pay invoices via VCN payments.

The POS terminal 308 determines if the instruction to initiate an invoice payment process is associated with a valid VCN. The POS terminal 308 transmits a message to the credit issuing bank system 304 to verify the VCN is valid (Operation 319).

The credit issuing bank system 304 analyzes its account data associated with the customer and the VCN to confirm the VCN is associated with the customer account and valid (Operation 320). If a customer's account is associated with one RCN and multiple VCNs, the credit issuing bank ensures the VCN is among the VCNs associated with the RCN. In addition, if the VCN is only valid for a single transaction, the credit issuing bank may verify that the VCN has not been used previously. In addition, the credit issuing bank may ensure that the VCN is associated with an identified customer request to pay invoices. If a VCN is associated with a time limit, the credit issuing bank may ensure the VCN has not expired.

If the credit issuing bank system 304 determines the VCN is valid, it transmits a confirmation to the POS terminal 308 (Operation 321). The POS terminal processes the payment.

The POS terminal 308 transmits an encrypted digital message that includes the VCN and a transfer amount to the supplier's financial institution 310 (Operation 322). The supplier's financial institution may be a bank where the supplier stores funds from invoice payments. The supplier's financial institution communicates with the credit issuing bank to transfer funds from the credit issuing bank to the supplier's financial institution using the VCN. For example, the supplier's financial institution 310 may send a funds transfer request, including the VCN and a transfer amount, to the credit issuing bank system 304 (Operation 324).

The credit issuing bank system transfers the funds from the account associated with the VCN to the supplier's financial institution (Operation 325).

One or both of the credit issuing bank system 304 and the supplier's financial institution 310 may generate payment confirmations (Operations 326 and 327). For example, the supplier's financial institution 310 may provide the credit issuing bank system 304 with a confirmation that a payment process was initiated or that funds were successfully transferred to the supplier's account in the supplier's financial institution 310. The supplier's financial institution 310 may provide the supplier system 306 with a confirmation of payment. The supplier system 306 or the credit issuing bank system 304 may send a confirmation to the customer system 302 that a payment process was initiated or that funds were successfully transferred to the supplier's account in the supplier's financial institution 310.

While the example embodiment describes the credit issuing bank system 304 transmitting a payment instruction to the POS terminal 308 that includes a VCN, in an alternative embodiment, the credit issuing bank system 304 transmits a payment request directly to a supplier's financial institution 310 without first transmitting the request to the supplier system 306. In this embodiment, the issuing bank and the supplier's bank initiate and execute the transfer of funds associated with the invoice amounts specified by the customer system 302. Upon initiating and/or completing the funds transfer, the credit issuing bank system 304 or the supplier system 306 may notify the customer system 302 and the supplier system 306 of the funds transfer. In this embodiment, the credit issuing bank system 304 or the supplier system 306 includes the VCN transaction ID in a communication to the customer system 302 and the supplier system 306. The customer system 302 and the supplier system 306 identify the invoices associated with the VCN transaction ID to record the initiation and/or completion of the funds transfer. Accordingly, in this embodiment, the VCN number is not transmitted to or from the supplier system 306, improving the security of the transaction. In addition, the VCN number may not be transmitted to or from the customer system 302, improving the security of the transaction.

### 7. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

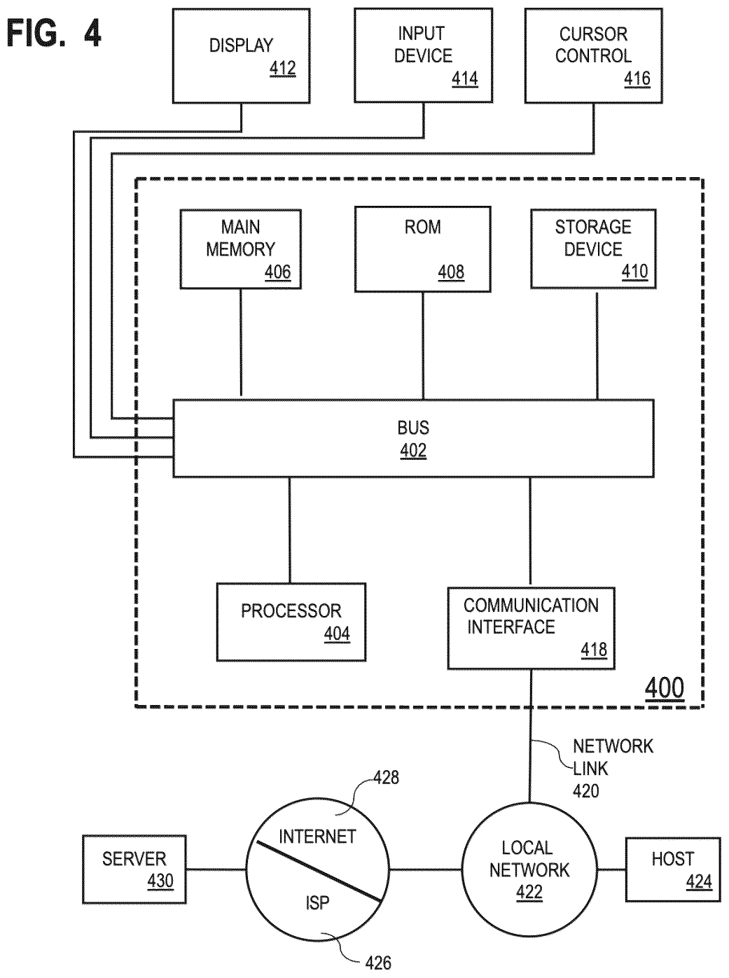

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general-purpose microprocessor.

Computer system 400 also includes a main memory 406, such as a random-access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid-State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory computer readable media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 9. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
receiving, by a point-of-sale (POS) terminal over the Internet, an instruction to initiate a payment to a supplier from a customer, wherein the instruction comprises an account number associated with a first account corresponding to the customer;
analyzing, by the POS terminal, the instruction to determine the account number associated with the first account corresponding to the customer;
generating by the POS terminal a new transaction request corresponding to the account number;
transmitting, by the POS terminal to a financial institution, the new transaction request, wherein the financial institution executes a payment process that transfers funds from the first account corresponding to the customer to a second account corresponding to the supplier; and
storing or presenting information indicating the processing of the payment was successful.

2. The non-transitory computer readable media of claim 1, wherein the account number, associated with the first account corresponding to the customer, is not accessible by the customer.

3. The non-transitory computer readable media of claim 1, wherein the account number is valid for one time use.

4. The non-transitory computer readable media of claim 1, wherein the instruction to initiate the payment is received from the financial institution to which the new transaction request is transmitted.

5. The non-transitory computer readable media of claim 4, wherein generating the request comprises grouping a plurality of invoices into a batch,
wherein the request includes batch data identifying the plurality of invoices, and
wherein the account number is valid for one time use for the plurality of invoices included in the batch.

6. The non-transitory computer readable media of claim 1, wherein executing the payment process comprises:
transmitting, by the POS terminal to a second device, an authorization request for processing the payment to the supplier based on the account number;
receiving, by the POS terminal, authorization information corresponding to the processing of the payment;
transmitting, by the POS terminal, a settlement request based on the authorization information for the processing of the payment; and
receiving, by the POS terminal, confirmation of the payment to the POS terminal.

7. The non-transitory computer readable media of claim 1, wherein the first device transmits the instruction to the POS in response to receiving a request from a customer to initiate the payment.

8. The non-transitory computer readable media of claim 1, wherein the account number comprises a Virtual Card Number (VCN).

9. The non-transitory computer readable media of claim 1, wherein the operations further comprise:
receiving, by the POS terminal, credit card information via a card reader, wherein the card reader determines the credit card information in response to a credit card being swiped through the card reader;
analyzing, by the POS terminal, the credit card information to determine a second account number corresponding to a third account;
generating by the POS terminal a second transaction request corresponding to the second account number; and
transmitting, by the POS terminal to the financial institution, the second transaction request for executing a second payment process that transfers a second payment from the third account to the second account corresponding to the supplier.

10. A method comprising:
receiving, by a point-of-sale (POS) terminal over the Internet, an instruction to initiate a payment to a supplier from a customer, wherein the instruction comprises an account number associated with a first account corresponding to the customer;
analyzing, by the POS terminal, the instruction to determine the account number associated with the first account corresponding to the customer;
generating by the POS terminal a new transaction request corresponding to the account number;
transmitting, by the POS terminal to a financial institution, the new transaction request, wherein the financial institution executes a payment process that transfers funds from the first account corresponding to the customer to a second account corresponding to the supplier; and
storing or presenting information indicating the processing of the payment was successful.

11. The method of claim 10, wherein the account number, associated with the first account corresponding to the customer, is not accessible by the customer.

12. The method of claim 10, wherein the account number is valid for one time use.

13. The method of claim 10, wherein the instruction to initiate the payment is received from the financial institution to which the new transaction request is transmitted.

14. The method of claim 13, wherein generating the request comprises grouping a plurality of invoices into a batch,
wherein the request includes batch data identifying the plurality of invoices, and
wherein the account number is valid for one time use for the plurality of invoices included in the batch.

15. The method of claim 10, wherein executing the payment process comprises:
transmitting, by the POS terminal to a second device, an authorization request for processing the payment to the supplier based on the account number;
receiving, by the POS terminal, authorization information corresponding to the processing of the payment;
transmitting, by the POS terminal, a settlement request based on the authorization information for the processing of the payment; and
receiving, by the POS terminal, confirmation of the payment to the POS terminal.

16. The method of claim 10, wherein the first device transmits the instruction to the POS in response to receiving a request from a customer to initiate the payment.

17. The method of claim 10, wherein the account number comprises a Virtual Card Number (VCN).

18. The method of claim 10, further comprising:
receiving, by the POS terminal, credit card information via a card reader, wherein the card reader determines the credit card information in response to a credit card being swiped through the card reader;
analyzing, by the POS terminal, the credit card information to determine a second account number corresponding to a third account;
generating by the POS terminal a second transaction request corresponding to the second account number; and
transmitting, by the POS terminal to the financial institution, the second transaction request for executing a second payment process that transfers a second payment from the third account to the second account corresponding to the supplier.

19. A point-of-sale (POS) terminal comprising:
a hardware processor; and
memory storing instructions, wherein the hardware processor is configured to execute the instructions to perform operations comprising:
receiving, over the Internet, an instruction to initiate a payment to a supplier from a customer, wherein the instruction comprises an account number associated with a first account corresponding to the customer;
analyzing the instruction to determine the account number associated with the first account corresponding to the customer;
generating a new transaction request corresponding to the account number;
transmitting, to a financial institution, the new transaction request, wherein the financial institution executes a payment process that transfers funds from the first account corresponding to the customer to a second account corresponding to the supplier; and
storing or presenting information indicating the processing of the payment was successful.

20. The POS terminal of claim 19, wherein the instruction to initiate the payment is received from the financial institution to which the new transaction request is transmitted.
